(19) United States
(12) Patent Application Publication
(10) Pub. No.: US 2005/0250492 A1
(43) Pub. Date: Nov. 10, 2005

(54) Method for suspending roaming

(76) Inventor: Han Kuang Chang, Taipei (TW)

Correspondence Address: BIRCH STEWART KOLASCH & BIRCH, PO BOX 747, FALLS CHURCH, VA, 22040-0747, US

(21) Appl. No.: 10/841,521

(22) Filed: May 10, 2004

(51) Int. Cl. H04Q 7/20

(52) U.S. Cl. 455/432.1; 455/445

(57) ABSTRACT

A method for suspending roaming in a mobile communication device. The mobile communication device is connected to the Internet and moves in a plurality of routing areas each comprising a gateway. The method determines whether the mobile communication device is roaming through the routing areas. If the mobile communication device is roaming, it is determined whether the mobile communication device is transporting payload data. When transport of the payload data is complete, the roaming is suspended.

### BACKGROUND OF THE INVENTION

1. Field of the Invention

The present invention relates to wireless communication, and in particular to method for suspending roaming in a mobile communication device.

2. Description of the Related Art

Access the Internet via a mobile communication device, such as a mobile phone or a personal digital assistant capable of wireless communication has become popular. A wireless mobile communication device enables wireless connection to the Internet regardless of location. FIG. 1 is a schematic diagram of a network system wherein a mobile communication device is connected to the Internet while moving.

Mobile phone 5 connects to the Internet at point D in the routing area 20a and then moves along a path 70 to routing 20b and 20c sequentially. Routing areas 20a, 20b and 20c respectively comprise router 10a, 10b and 10c as gateways through which mobile devices connect to Internet. Router 10a, 10b and 10c comprise Internet Protocol (IP) addresses respectively. Routing area 20a comprises coverage range of base stations 301 and 302. Routing area 20b comprises coverage range of base stations 303 and 304. Routing area 20c comprises coverage range of base stations 305 and 306. a connection to the Internet as it moves from routing area 20a of router 10a to another routing area. A gateway, such as router 10a, through which a mobile phone initiates an Internet connection is referred to as a home agent of mobile phone 5. In addition to the home agent, other gateways, such as routers 10b or 10c, which serve and enable mobile phone 5 to roam is referred to as a foreign agent of mobile phone 5.

Roaming is implemented by a tunneling method. In the tunneling method, mobile phone 5 continues to use an IP address provided by the home agent to communicate with the Internet thereby preventing communication suspension when roaming. The IP address of mobile phone 5 is the destination address of every packet sent thereto. The packets sent to mobile phone 5 are first sent to the home agent. When roaming, however, mobile phone 5 is no longer within the routing area 20a of the home agent. In the tunneling method, the home agent adds additional header information comprising the address of the foreign agent to the packets to ensure correct transmission of the packet to mobile phone 5. The foreign agent then transmits the packets to mobile phone 5.

This method, however, incrementally increases header size. When a packet with an additional header exceeds a pre-determined size, the packet must be divided into two packets. The two packets are transmitted to carry the same payload data as the previous packet from which the two packets are divided, thus the network payload transmission rate is decreased.

In addition, network systems conforming to General Packet Radio Service (GPRS) charge a fee for packet transmission and account for the number of packets transmitted via gateways. As a gateway, router 10a initiates an Internet connection for mobile phone 5. Router 10a is responsible for tracking number of packets to and from mobile phone 5. When roaming, for example, mobile phone 5 enters routing area 20b the router 10b of which begins counting the number of packets sent and received by mobile phone 5. Additionally, routers 10a and 10b synchronously count packets transported to and from mobile phone 5. In other words, the same packet is counted twice by routers 10a and 10b respectively, resulting in double charging.

Hence, roaming via the tunneling method causes decreased payload data transmission rate and double charging. Thus, there is a need for a method to solve the above-described disadvantage.

### SUMMARY OF THE INVENTION

Accordingly, the invention provides a method for suspending roaming in a mobile communication device. When the mobile communication device is connected to the Internet and moves through a plurality of routing areas each comprising a gateway, the method determines whether the device is roaming. If the mobile communication device is roaming, it is determined whether the mobile communication device is transporting payload data. When the mobile communication device is not transporting payload data, the roaming is suspended.

In addition, the method of the invention for suspending roaming can be implemented with a computer application recorded in a storage medium such as a memory or a memory device. The computer application, when loaded into a computer, directs the computer to execute the method for suspending roaming of the invention.

Additionally, the present invention provides a mobile communication device capable of suspending roaming. The mobile communication device is connected to the Internet and moves through a plurality of routing areas each comprising a gateway. The mobile communication device comprises a communication unit and a processing unit coupled thereto. The processing unit determines whether the mobile communication device is roaming. If the mobile communication device is roaming, the processing unit further detects whether the communication unit is transporting payload data. When the communication unit is not transporting payload data, the processing unit suspends the mobile communication device from roaming.

### DESCRIPTION OF THE DRAWINGS

The present invention can be more fully understood by reading the subsequent detailed description and examples with references made to the accompanying drawings, wherein:

FIG. 1 is a schematic diagram of a network system;

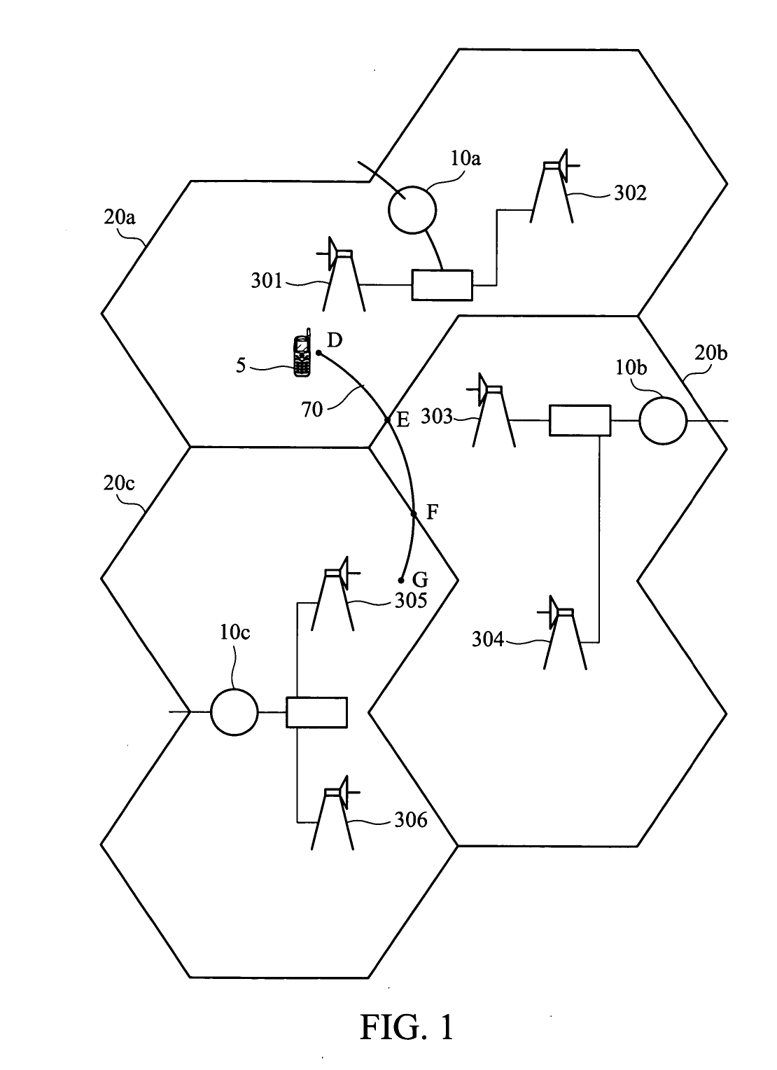

FIG. 2 is a block diagram of the mobile communication device of the invention; and

FIG. 3 is a flowchart of the method of the invention for suspending roaming.

### DETAILED DESCRIPTION OF THE INVENTION

The present invention provides a roaming suspension method in a mobile communication device, which can be implemented by a computer program stored in a storage medium.

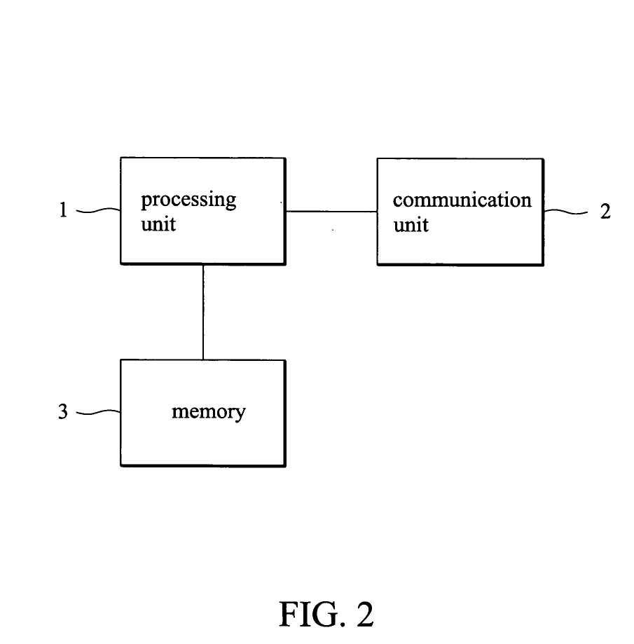

In the invention, a mobile phone moving through a plurality of routing areas is given as an example. This is not intended to limit the invention. The roaming suspension method can be implemented in other mobile communication devices. Mobile phone 5, as shown in FIG. 2, comprises processing unit 1, communication unit 2 and memory 3.

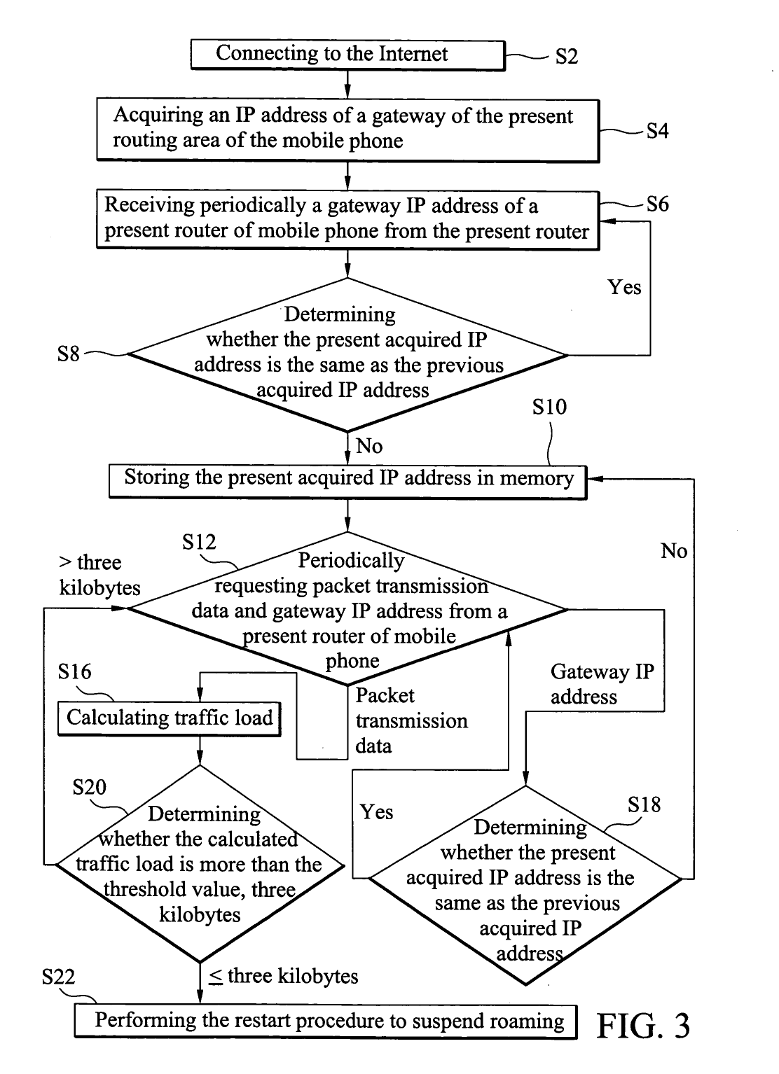

FIG. 3 is a flowchart of the roaming suspension method of the invention. When finishing authenticated and after have been provided an IP address by router 10a, mobile phone 5 connects to the Internet (step S2). Communication unit 2 initiates communication with the Internet, and processing unit 1 initiates a program for executing the method for roaming suspension. The program may be a memory-resident program which terminates when the mobile phone disconnects from the Internet.

A routing area where mobile phone 5 exists is hereafter referred to as a present routing area of mobile phone 5, and a router therein serving mobile phone 5 is hereafter referred as a present router of mobile phone 5. Processing unit 1 acquires an IP address of a gateway of the present routing area of the mobile phone 5 (step S4) and stores the acquired IP address as a first gateway IP address in memory 3.

Processing unit 1 periodically requests and receives a gateway IP address of a present router of mobile phone 5 from the present router (step S6). Thus processing unit 1 can identify the information whether mobile phone 5 has switched to a new routing area. When a GPRS mobility management system lacks a mechanism for notifying a mobile communication device of the information, the described process can be adopted. If a GPRS mobility management system supports the above-described mechanism, processing unit 1 is notified of and receives the IP address of a present router of mobile phone 5.

For example, processing unit 1 requests and receives the IP address of the present router of mobile phone 5 every three seconds. Processing unit 1 determines whether the present acquired IP address is the same with the previous acquired IP address (step S8). For example, after acquiring a second gateway IP address following the first gateway IP address, processing unit 1 determines whether the second gateway IP address is the same with the first gateway IP address.

When the present acquired IP address is the same as the former acquired IP address, processing unit 1 determines that mobile phone 5 is not roaming. Processing unit 1 returns to step S6 to repeat acquiring a gateway IP address of a present router. When the present acquired IP address is different from the previously acquired IP address, processing unit 1 determines that mobile phone 5 is roaming. Processing unit 1 stores the present acquired IP address as the first gateway IP address in memory 3 to replace the previously acquired IP address (step S10).

When mobile phone 5 is identified as roaming, processing unit 1 further determines whether mobile phone 5 is transporting payload data. To prevent interruption of the Internet connection of mobile phone 5, processing unit 1 does not perform a restart procedure described later in this specification until transport of the payload data is complete.

Processing unit 1 determines whether communication unit 2 is transporting payload data by detecting traffic load between communication unit 2 and the Internet. In the invention, three kilobytes is adopted as a traffic load threshold value. System signals are frequently transported between communication unit 2 and Internet, but traffic load of system signal transportation is typically lower than three kilobytes. Conversely, the traffic load of payload transportation is typically more than three kilobytes.

Processing unit 1 periodically requests packet transmission data and derives a traffic load therefrom. The packet transmission data comprises at least the total number of packets or total size thereof transported to and from communication unit 2 during a period of time. In the preferred embodiment, processing unit 1 periodically requests packet transmission data and gateway IP address from a present router of mobile phone 5 (step S12). Processing unit 1 derives traffic load by subtracting a previous packet transmission data value from a present packet transmission data value. Thus, processing unit 1 can detect whether mobile phone 5 is moving to another routing area during transporting payload data.

For example, when mobile phone 5 moves along path 70 from point D to point E during transporting payload data, processing unit 1 identifies that mobile phone 5 is roaming to routing area 20b and then detects whether mobile phone 5 is transporting payload data. Mobile phone 5 may continue transporting payload data while moving from point E to point G in routing area 20c as a present routing area of mobile phone 5. Processing unit 1 can identify if the present routing area of mobile phone 5 is routing area 20c only when keeping periodically detecting the gateway IP address of a present router of mobile phone 5 in addition to detecting traffic load.

When receiving a gateway IP address, processing unit 1 performs address comparison to determine whether the present IP address is the same as the former IP address (step S18). If so, processing unit 1 returns to step S12 to periodically request packet transmission data and gateway IP address from a present router of mobile phone 5 (step S12). If not, processing unit 1 identifies that mobile phone 5 is roaming to another routing area. Then processing unit 1 returns to step S10 and stores the present acquired gateway IP address as the first gateway IP address in memory 3 (step S10). Processing unit 1 then returns to step S12 to periodically request packet transmission data and gateway IP address from a present router of mobile phone 5 (step S12).

When receiving packet transmission data, processing unit 1 stores the acquired packet transmission data in memory 3 and calculates traffic load by subtracting a former packet transmission data value from a current packet transmission data value (step S16). Processing unit 1 then determines whether the calculated traffic load is more than the threshold value of three kilobytes (step S20). If so, communication unit 2 is determined as transporting payload data. Processing unit 1 then returns to step S12. If the calculated traffic load is less than the threshold value, communication unit 2 is determined to have finished transporting payload data. Processing unit 1 then performs the restart procedure to suspend roaming (step S22).

In the restart procedure, processing unit 1 disconnects communication unit 2 from the Internet. Processing unit 1 connects communication unit 2 to the Internet, wherein the mobile phone 5 is assigned a new IP address by a present router thereof. Roaming is suspended without interrupting payload data transportation. All packets, destination address of which is the new assigned IP address, are directly routed to the present router of mobile phone 5 rather than the home agent. Additional header information described above is avoided, thus only a present router of mobile phone 5 counts packet amount thereof for charge. Thus, payload data transmission rate and double charging problems in tunneling method are ameliorated.

To achieve an object of determining whether mobile phone 5 is roaming, processing unit 1 periodically requests and compares gateway IP addresses. The object may be achieved using other methods which should be included in the scope of the invention. For example, a network system with the above-described mechanism may notify mobile phone 5 when roaming is initiated. Otherwise, processing unit 1 may be notified of gateway IP addresses via gateways.

To achieve another object of determining whether mobile phone 5 is transporting payload data, processing unit 1 periodically requests packet amount and derives traffic load therefrom. The object, however, may be achieved by other methods. For example, processing unit 1 detects data in a buffer cache of communication unit 2 to achieve the object. Otherwise, a bit may be adopted for representing the transmission status. The bit is set to logic “1” when a payload transmission is initiated by a user demand. The bit is set to logic “0” when the payload transmission is complete and the user demand is satisfied. Processing unit 1 may detect the bit to achieve the object.

Therefore, the method for suspending roaming of the present invention ameliorates the above-described disadvantages.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A method for suspending roaming in a mobile communication device connected to the Internet moving through a plurality of routing areas each comprising a gateway, comprising the steps of:
determining whether the mobile communication device is roaming;
detecting whether the mobile communication device is transporting payload data if the mobile communication device is roaming; and
suspending roaming when the mobile communication device is not transporting payload data.

2. The method as claimed in claim 1, wherein the gateway of each routing area comprising an identification, the determining step further comprises the steps of:
acquiring a first identification which is an identification of a gateway of a first routing area where the mobile communication device exists;
acquiring a second identification which is an identification of a gateway of a second routing area where the mobile communication device exists;
determining whether the first identification is the same as the second identification; and
determining that the mobile communication device is roaming when the first identification is different from the second identification.

3. The method as claimed in claim 2, wherein the identification comprises an internet protocol (IP) address.

4. The method as claimed in claim 1, further comprising the step of determining whether the mobile communication device as transporting payload data when traffic load between the mobile communication device and the Internet is more than a threshold value.

5. The method as claimed in claim 4, wherein the threshold value is three kilobytes.

6. The method as claimed in claim 1, wherein the suspension step further comprising the steps of:
disconnecting the mobile communication device from the Internet to suspend roaming; and
connecting the mobile communication device to the Internet, where the mobile communication device is assigned a new Internet protocol address by a gateway of a third routing area wherein the mobile communication device exists.

7. A machine-readable storage medium storing a computer program which, when executed, directs a mobile communication device to perform a method for suspending roaming, wherein the mobile communication device is connected to the Internet and moving through a plurality of routing areas each comprising a gateway, comprising the steps of:
determining whether the mobile communication device is roaming in the routing areas;
detecting whether the mobile communication device is transporting payload data if the mobile communication device is roaming; and
suspending roaming when the mobile communication device is not transporting payload data.

8. The storage medium as claimed in claim 7, wherein the gateway of each routing area comprising an identification, the determining step further comprises the steps of:
acquiring a first identification which is an identification of a gateway of a first routing area where the mobile communication device exists;
acquiring a second identification which is an identification of a gateway of a second routing area where the mobile communication device exists;
determining whether the first identification is the same as the second identification; and
determining that the mobile communication device is roaming when the first identification is different from the second identification.

9. The storage medium as claimed in claim 8, wherein the identification comprises an internet protocol (IP) address.

10. The storage medium as claimed in claim 7, wherein the method further comprises the step of determining the mobile communication device as transporting payload data when traffic load between the mobile communication device and the Internet is more than a threshold value.

11. The storage medium as claimed in claim 10, wherein the threshold value is three kilobytes.

12. The storage medium as claimed in claim 11, wherein the suspension step further comprises the steps of:
disconnecting the mobile communication device from the Internet to suspend roaming; and
connecting the mobile communication device to the Internet, wherein the mobile communication device is assigned a new Internet protocol address by a gateway of a third routing area where the mobile communication device exists.

13. A mobile communication device for suspending roaming, connected to the Internet and moving through a plurality of routing areas each comprising a gateway, comprising:
a communication unit; and
a processing unit coupled to the communication unit, determining whether the mobile communication device is roaming, detecting whether the communication unit is transporting payload data if the mobile communication device is roaming, and suspending roaming when the communication unit is not transporting payload data.

14. The mobile communication device as claimed in claim 13, wherein the gateway of each routing area comprises an identification, the processing unit acquires a first identification which is an identification of a gateway of a first routing area where the mobile communication device exists and then acquires a second identification which is an identification of a gateway of a second routing area where the mobile communication device exists, the processing unit determines whether the first identification is to the same as the second identification, and the processing unit determines that the mobile communication device is roaming when the first identification is different from the second identification.

15. The mobile communication device as claimed in claim 14, wherein the identification comprises internet protocol (IP) address.

16. The mobile communication device as claimed in claim 13, wherein the processing unit further determines the communication unit as transporting payload data when traffic load between the mobile communication device and the Internet is more than a threshold value.

17. The mobile communication device as claimed in claim 16, wherein the threshold value is three kilobytes.

18. The mobile communication device as claimed in claim 13, wherein the processing unit further disconnects the mobile communication device from the Internet and then connects the mobile communication device to the Internet to suspend roaming, and the mobile communication device is assigned a new Internet protocol address by a gateway of a third routing area where the mobile communication device exists.
